(19) United States
(12) Patent Application Publication
(10) Pub. No.: US 2021/0083757 A1
(43) Pub. Date: Mar. 18, 2021

(54) PASSIVE EXTENDER COMMUNICATION SYSTEM FOR WIRELESS ELEVATOR COMMUNICATION

(71) Applicant: Bruce David Gustafson, Houston, TX (US)

(72) Inventor: Bruce David Gustafson, Houston, TX (US)

(21) Appl. No.: 16/905,548

(22) Filed: Jun. 18, 2020

Related U.S. Application Data
(60) Provisional application No. 62/836,055, filed on Apr. 18, 2019.

(51) Int. Cl. H04B 7/155; H01Q 13/20

(52) U.S. Cl. CPC H04B 7/15514; H01Q 13/203

(57) ABSTRACT

A communication system provides wireless communication in locations of restricted movement. Restricted movement may include static locations (for example, buildings and tunnels) or moving vehicles (for example, elevators, trains, and ships). A wireless antenna may be connected to an external telecommunications source through a radiant cable. Wireless signals may thus provide communication from locations that were previously subject to spotty or unreachable signal. Direct communication from occupants may be provided. Some embodiments may provide monitoring or equipment or the environment that previously required a hardwired line.

### CROSS-REFERENCE TO RELATED APPLICATIONS

This application claims benefit under 35 U.S.C. § 119(e) of U.S. Provisional application having Ser. No. 62/836,055 filed on Apr. 18, 2019, which is hereby incorporated by reference herein in its entirety.

### BACKGROUND

The embodiments herein relate generally to communication systems, and more particularly, to a passive extender communication system for wireless elevator communication.

Restricted movement locations and vehicles have conventionally had limited means to communicate with external entities. Due to the insulated nature of such locations/vehicles, communication has been performed by hardwire. Since many such locations/vehicles were invented before wireless communication technologies, their design has been challenging for use of current wireless frequencies. In many instances, wireless signaling in restricted spaces is inoperable or subject to strong interference from the walls surrounding the space.

Elevators for example are prone to being a dead zone for wireless signals because of their movement and the surrounding concrete walls. Elevators generally communicate by a hardwired phone box that is connected to a physical station operated by a person in the building. However, this has been long felt dangerous situation if the call box is inoperable or no one is manning the call station connected to the elevator phone. People have been trapped in elevators for lengthy periods because they were unable to communicate with the outside world.

Moreover, elevators and the like tend to rely on stale technology that requires in-person monitoring and inspection because of the constraints of communication.

As can be seen, there is a need for a communication system for restricted locations and vehicles that improves upon conventional hard-wired systems.

### SUMMARY

According to one aspect of the subject technology, a passive extender communication system for wireless elevator communication or in other places of restricted movement is disclosed. The system comprises: a first antenna assembly mounted to an interior of an elevator car, wherein the first antenna assembly is configured to receive and transmit wireless radio frequency (RF) signals from the interior of the elevator car to an exterior of the elevator car; a radiant antenna cable positioned in an elevator shaft, wherein the radiant antenna cable is RF linked to the first antenna assembly; and a telecommunication signal source connected to the radiant antenna cable, wherein: the telecommunication signal source is positioned externally from the elevator car, and the telecommunication signal source is configured to transmit RF signals to the first antenna assembly and to receive RF signals from the first antenna assembly, through the radiant antenna cable.

According to another aspect, a communication system for wireless communication in locations of restricted movement is disclosed. The system comprises: a wireless antenna mounted to an interior of the location of restricted movement, wherein the wireless antenna is configured to receive and transmit wireless radio frequency (RF) signals; a radiant antenna cable positioned in or proximate to the location of restricted movement, wherein the radiant antenna cable is RF connected to the wireless antenna; and a telecommunication signal source connected to the radiant antenna cable, wherein: the telecommunication signal source is positioned externally from the location of restricted movement, and the telecommunication signal source is configured to transmit RF signals to the wireless antenna and to receive RF signals from the wireless antenna through the radiant antenna cable.

### BRIEF DESCRIPTION OF THE FIGURES

The detailed description of some embodiments of the present invention is made below with reference to the accompanying figures, wherein like numerals represent corresponding parts of the figures.

FIG. 1 is a top cross-sectional schematic view of a passive extender communication system in an elevator shaft in accordance with an exemplary embodiment of the subject technology.

FIG. 2 is a side schematic view of the system of FIG. 1.

FIG. 3 is a schematic view of the system of FIG. 1 implemented in an elevator complex in accordance with an embodiment.

FIG. 4 is a side view of a disconnected wireless antenna projecting internally into an elevator car through a wall of the elevator in accordance with an exemplary embodiment of the subject technology.

FIG. 5 is a partial view of an interior of an elevator shaft showing a connection between a wireless antenna assembly being mounted to an elevator car and a radiant cable in the shaft in accordance with an exemplary embodiment of the subject technology.

FIG. 6 is a block diagram of a passive extender communication system for locations of restricted movement in accordance with an exemplary embodiment of the subject technology.

FIG. 7 is a block diagram of Industrial Internet of Things devices connected to a passive wireless antenna system in accordance with an exemplary embodiment of the subject technology.

### DETAILED DESCRIPTION OF CERTAIN EMBODIMENTS

The word “exemplary” is used herein to mean “serving as an example or illustration.” Any aspect or design described herein as “exemplary” is not necessarily to be construed as preferred or advantageous over other aspects or designs.

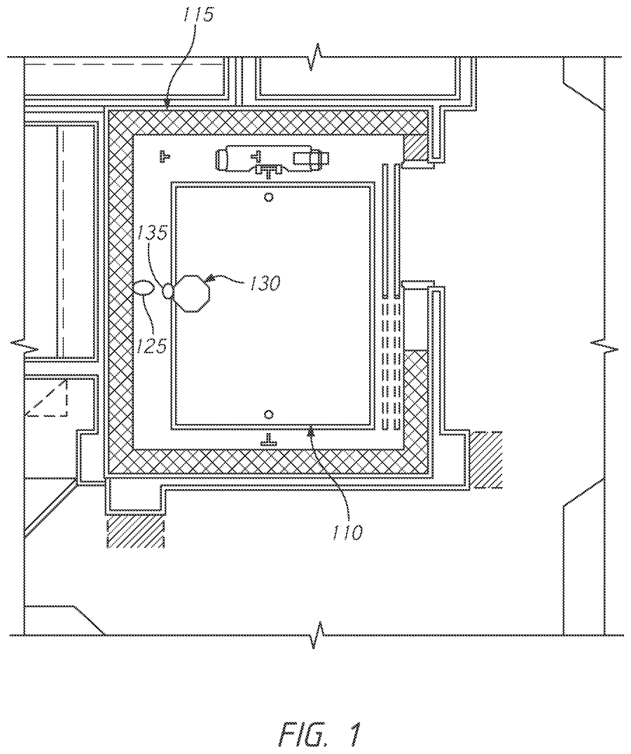

Referring to FIGS. 1-7 in general, a passive extender communication system 100 (referred to generally as the “system 100”) for wireless communication places of restricted movement is shown according to an exemplary embodiment. In the embodiments discussed below, for sake of illustration, the system 100 is shown in the context of an elevator car application. However, it should be understood that the system 100 may be adapted for other applications where restricted movement of a person may be found and communication outside of the location of restricted movement is conventionally hardwired inside the location. For example, as will be appreciated, the overall design of the system 100 provides a new level of flexibility for buildings, tunnels, trains, ships, and vehicle applications. In buildings where there is little or no space to run additional cables or provide a powered solution, system 100 allows for example, existing RF sources to transmit signals now into restricted areas that were never achievable before either due to structure or cost. For example, in steel ships the system 100 allows communication through steel walls and bulkheads for communication without having to run additional powered cables. In military vehicles, system 100 allows for the installation of antennas from the inside of the vehicle though its design of a reverse collar that seals the hole due to positive internal pressure in the vehicle). This way system 100 maintains a positive air flow from inside to out for CBRN (Chemical, Biological, Radiological, and Nuclear) operations and if the antenna is broken the operator does not need to leave the inside of the vehicle to change out the antenna which eliminates exposure to dangers outside of the vehicle and also maintain the CBRN integrity of the vehicle. Changing out this communication antenna would take less than 45 seconds during combat operations. For trains and subway's running through tunnels system 100 provides a cost effective solution for system operators by using only passive devices on trains thereby keeping cost and maintenance to almost nothing and at the same time having a reliable cable system in the shaft that can be run thousands of feet.

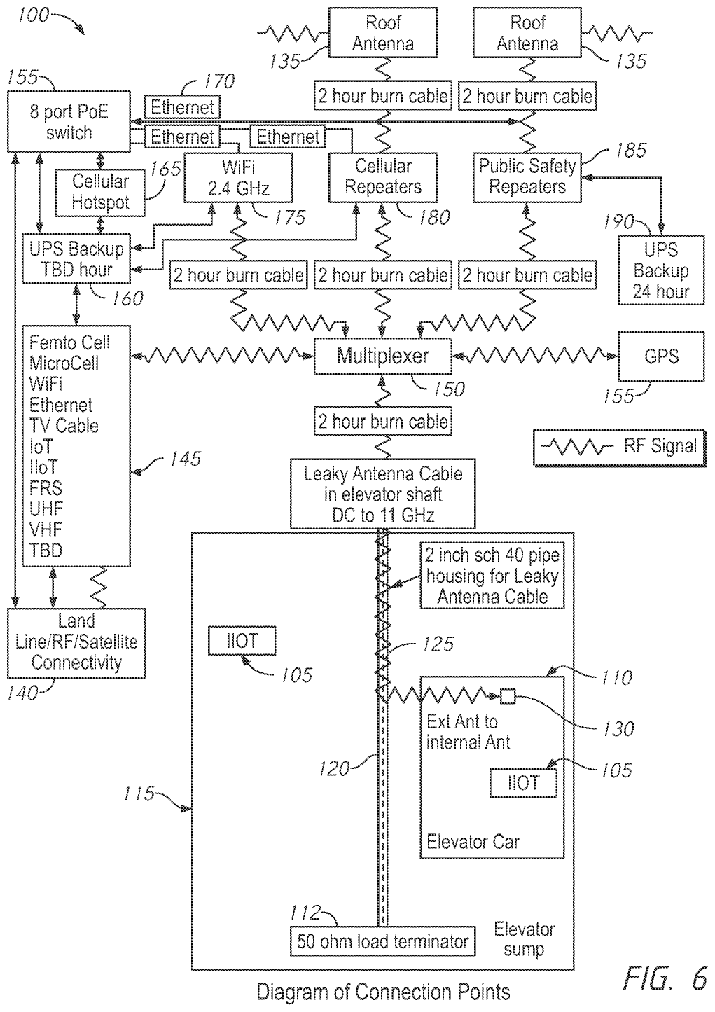

FIGS. 1-5 show the system 100 in the context of an elevator car application. An overall embodiment of the system 100 can be seen in FIG. 6.

Generally speaking, the system 100 includes a passive wireless antenna assembly system 130 mounted to the interior space of the location of restricted movement, which may be connected to a telecommunication signal source. In the claims, the passive wireless antenna system 130 may be referred to as a “first antenna” while the telecommunication signal source generally refers to one or more second antennas or sources of RF signals. The passive wireless antenna system 130 may be linked to a radiant antenna cable 125 (which may be also known as a “radiating cable”). The radiant cable 125 may be connected to the telecommunication signal source. As will be appreciated, communications in locations like elevator cars 110 have been generally limited to hardwired systems. Most any type of communication required a direct wiring between the element in the elevator car (or other restricted space) and the end recipient element. This limits the type of communication available between the elevator car and outside elements for practical purposes. However, aspects of the system 100 allow various applications of communication to occur.

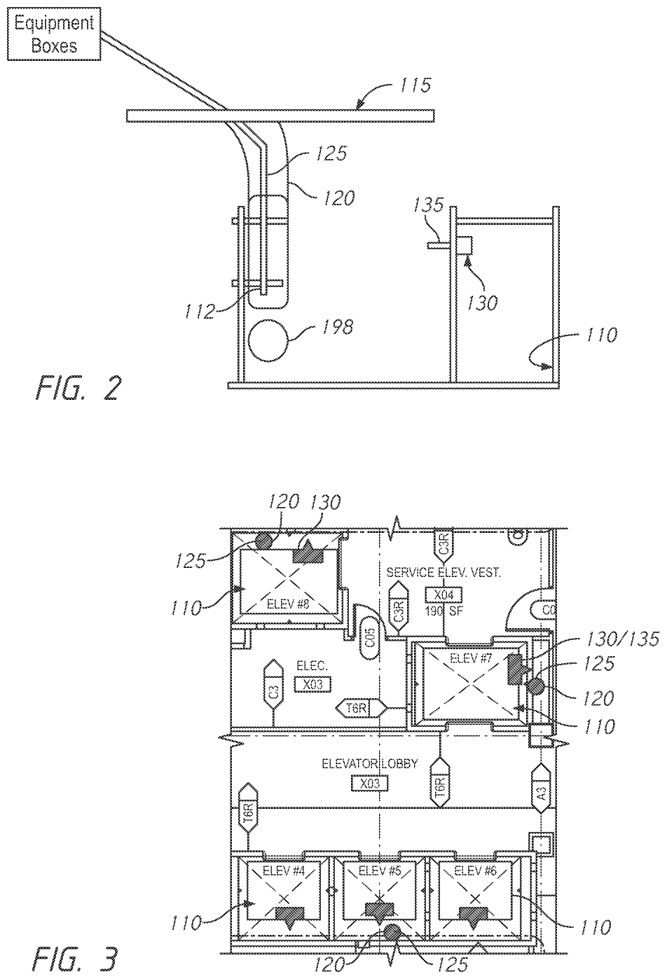

In an exemplary embodiment, the radiant antenna cable 125 may be positioned in the elevator shaft 115. Signals received by the passive wireless antenna assembly system 130 may be transmitted to the telecommunication signal source and vice versa, the telecommunication signal source may transmit signals to the end device communicating with the passive wireless antenna system 130. In some embodiments, the radiant antenna cable 125 may be housed within a conduit 120. The conduit 120 (and antenna cable 125) may be in-line with or offset from the passive wireless antenna system 130. A load terminator 112 of the radiant antenna cable 125 may be at a terminal end of the radiant antenna cable 125 and located near the elevator sump. The load terminator 112 may be protected by an end cap 198 on the conduit 120 (represented by the circle shown in FIG. 2).

In an exemplary embodiment, the radiant antenna cable 125 may be a leaky-wave antenna. The radiant antenna cable 125 supports frequencies from just above DC (0 Hertz) to up to 11 GHz. The conduit 120 may be a Sch40 PVC pipe that is UL rated that may be mounted on the vertical wall of an elevator shaft or any type of vertical or horizontal travelling car zone. The radiant antenna cable 125 may be plenum rated for fire and waterproof for a minimum of 10 years against water intrusion. Sch40 PVC pipe is also watertight. The conduit 120 may heave a glued-on dust cover at the end next to the elevator sump and at the top of the radiant antenna cable 125 where it exits the shaft into the communication closet. The conduit 120 may have a firewall type penetration that is fire caulked. The conduit 120 may provide enough space for different diameters of cables based on frequency and power requirements with connectors and 50-ohm matching load terminators. The conduit 120 may be mounted directly on the shaft wall and/or on a standoff to provide better radiation pattern. In some embodiments, the conduit 120 may be a 2-inch PVC pipe configured to carry two cables: one for Public Safety Communication supporting First Net and Older P25 frequencies working in the 700, 800, UHF, and VHF channels. The 2nd cable may support FRS, WiFi, Cellular, GPS, IoT, and other to be determined frequencies including leaky antenna cameras, wireless smoke detectors, and other devices as required that need a RF communication link to support them. Based on the Public Safety Requirements for the jurisdiction the elevator is located, a single cable may be used with a frequency mixer/multiplexer (for example, the multiplexer 150) developed to support all public safety channels, IIoT, IoT, WiFi, Cellular, FRS, GPS, and all other to be determined frequencies in a single radiant cable assembly. In an exemplary embodiment, the multiplexer 150 is designed to work as a system integration platform that allows frequencies of different types to be installed at the same input location. For example, the multiplexer 150 may have the cellular input from 600 to 2700 MHz, WiFi may be at 5 to 7 GHz, UHF input may be at UHF 30 MHz to 300 MHz, VHF may be from 300 MHz to 3 GHz, and etc. This multiplex frequency scheme may be useful for Navy and Well Drilling ships where the use of standard handheld VHF radios cannot work inside the steel hulled ships where communications is key when talking from pump rooms located 60 feet below the water line to support ships that are on the outside of the ship providing assistance and direction in for example, firefighting scenarios. In an exemplary embodiment, the radiant antenna cable 125 may be configured to match the frequency ranges of applications processed by the multiplexer 150. In some embodiments, the load termination 112 may also be configured to work for the different frequencies. The internal antenna assembly 130 may also carry all these frequencies. It should be appreciated however, that in combination, it may be a challenge to match up the radiant antenna cable 125, the internal antenna assembly 130, the load termination 112, and the multiplexer 150 to all cooperate at any given time on any of the above frequency ranges and given that different frequency bands may be in use simultaneously through the system 100.

The radiant antenna cable 125 may be low smoke, non-halogenated, fire retardant, and may conform to UES332-1, IEX332-3C, UL-1666 or UL1685-12, or (FT4/IEEE1202, NFPA-130), CMR or CMG-LS standards.

The radiant antenna cable 125 may be a 50-ohm radiant cable that can be sized to the elevator height from ½ inch up to 1⅝ inches depending on the size and length of the elevator shaft. While only a single radiant antenna cable 125 is shown, it may be appreciated that the system 100 may include additional Localized Amplification System (LAS) (which may refer to any of the individual radio type sub-systems (for example, cellular, WiFi, UHF, VHF, etc.)) and radiant antenna cables 125 be installed in the shaft in a stacked fashion if the shaft is of great height. It is presently estimated that present low power systems will provide communication to shafts from 10 to 400 feet in length and high-power systems will provide communication to shafts from 10 to 1800 feet in length with no issues.

Referring to FIG. 3, some embodiments may include multiple implementations of the system 100 to a plurality of elevator cars 110. As shown, some elevator cars 110 may have (a dedicated radiant antenna cable 125. In some embodiments, elevator cars 110 (for example, those shown at the bottom of the figure) may connect to a shared conduit 120 which may contain a shared radiant antenna cable 125 in-common (for example, by spliced connection) or multiple radiant antenna cables 125.

Referring now to FIGS. 1, 2, 4, and 5, details of the relationship between the passive wireless antenna system 130 and the radiant antenna cable 125 are shown according to an exemplary embodiment. In an exemplary embodiment, the passive wireless antenna assembly system 130 may comprise two antenna modules: an inside antenna module 133 (which may be positioned in the elevator car 110) and an outside antenna element 135 (which may project out of the elevator car 110 through an elevator wall 118 into the elevator shaft 115). The inside antenna module 133 may be a flat panel type antenna configured to receive signals from devices in the elevator car 110 and transmit signals to the outside antenna element 135 (which may return signals back). A cable may connect the inside antenna module 133 to the outside antenna element 135 via, for example, and SMA connection. The outside antenna element 135 may be a single di-pole type antenna configured to receive signals from the inside antenna module 133 and re-transmit those signals wirelessly to the radiant antenna cable 125 (and vice versa). As depicted in FIGS. 1 and 2, the radiant antenna cable 125 is within a range of RF communication with the outside antenna element 135. The link between the radiant antenna cable 125 and the outside antenna element 135 is based on radio frequency communication. As the elevator car 110 moves up and down the shaft 115, the outside antenna element 135 travels parallel to the radiant antenna cable 125, which picks up signals from the outside antenna element 135 even during elevator movement since the distance between the two elements remains fairly constant. Return signals from exterior telecommunication sources are returned by the radiant antenna cable 125 to the outside antenna element 135 back into the elevator car 110 to the inside antenna module 133 and back to devices in (or attached to) the elevator car 110.

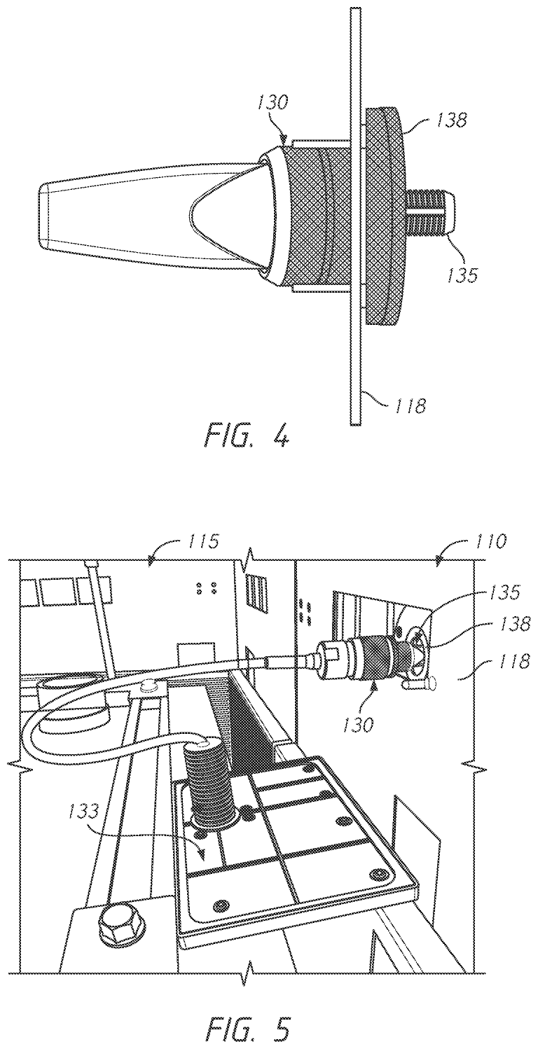

In some embodiments, the inside antenna module 133 may be positioned above the drop ceiling and placed just above the return air gap between the drop ceiling and the side of the elevator car 110. The outside antenna element 135 protrudes through the wall 118 of the elevator car 110 having direct access to the open air in the interior of the shaft 115. The design is such the passive wireless antenna system 130 will not interfere with the operation of an escape hatch or fireman walking on the top of the elevator car 110. In some embodiments, the passive wireless antenna system 130 may include a reverse collar 138 (see FIGS. 4 and 5) that when installed, may be on the interior of the elevator car 110 and which prevents the outside antenna element 135 from falling into the elevator shaft 115.

In one aspect, it will be appreciated that cellular/mobile communication may occur between occupants of the elevator car 110 and outside entities. In conventional elevator car communication systems, cellular/mobile communications typically suffer due to the enclosed and insulated nature of an elevator system. User mobile devices (not shown) may now communicate through the passive wireless antenna assembly system 130 to a variety of telecommunication signal sources (described with examples in FIG. 6). In addition, some embodiments may be beneficial to the monitoring and maintenance of elevator cars 110 with the inclusion of Industrial Internet of things (IIoT) 105 that may be mounted in the elevator car 110 and external to the elevator car 110.

Referring now to FIG. 6, connections of various elements in the system 100 are shown more fully according an exemplary embodiment. Some embodiments may include a plurality of IIoT devices 105 mounted in and outside of the elevator car 110. IIoT mounted outside the elevator car may be on an exterior surface of the elevator car 110 or on walls or support structures in the elevator shaft 115. Data from the IIoT devices 105 may be transmitted to the passive wireless antenna system 130 which may re-direct the signals to the telecommunication signal source(s).

The telecommunication signal source(s) may include one or more devices which may be configured to communicate with other RF devices (not shown) that are not part of the building that has the elevator car 110. The telecommunication signal source may include passive antennas and/or a repeater systems of signal repeaters. In some embodiments, the system 100 may include a multiplexer 150 which may manage the routing of different signals to/from the passive wireless antenna system 130 to a compatible telecommunication signal source based on their frequency and/or data format. While the following is a list of examples of telecommunication signal sources, it will be understood that other types may be contemplated and do not depart from the disclosure provided. Telecommunication signal sources may include for example, passive roof antennas 135 which broadcast an end signal from other signal devices to an external entity. Some embodiments may include repeaters (for example, a cellular signal repeater 180 and a public safety band repeater 190 are shown but other types may be included) between antenna cable 125 (and/or the multiplexer 150) and the device compatible with the signal received from the passive wireless antenna system 130.

A “repeater” may be any device that provides the RF source power to drive the radiant antenna cable 125 placed in the elevator shaft. A repeater may operate under cellular, public safety communications, TV, VHF UHF, WiFi, GPS, IoT, FRS or any other known or unknown standard that has a 50- or 75-ohm impedance transmitter/receiver. In this example all items are run at 50-ohm impedances.

Block 140 represents different types of connectivity formats (for example, land line, RF, and satellite) that may be managed by the repeater section of system 100. Land line signals may connect to a power over Ethernet (PoE) switch 155 which may be connected to Ethernet ports 170. The Ethernet ports 170 may be connected to a WiFi antenna 175 or to the roof antenna 135. For wireless applications (RF signals or satellite), wireless signal controller 145 may be a cellular hotspot 165 and/or the PoE switch 155. The cellular hotspot 165 may in some embodiments, be connected to the PoE switch 155 and/or the WiFi antenna 175. Some embodiments may include a universal power supply (UPS) backup module 160 between the wireless signal controller 145 and the PoE switch 155 and/or the WiFi antenna 175. Some embodiments may include a GPS antenna 155 that may be connected directly to the antenna cable 125 and/or the multiplexer 150 since the GPS antenna 155 may be capable of communicating with external entities without any additional intervening elements. FIG. 6 shows that some embodiments may include 2 hour rated burn cables connecting elements outside of the elevator shaft in the system 100.

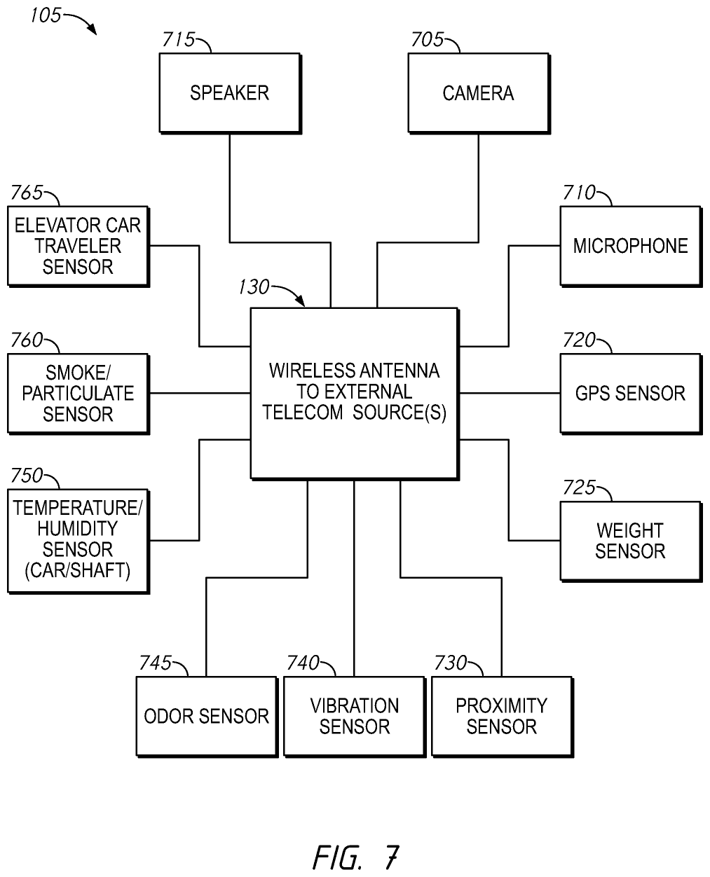

Referring now to FIG. 7, a plurality of IIoT devices 105 connected to the passive wireless antenna system 130 are shown according to embodiments. As will be appreciated, since the passive wireless antenna system 130 provides a variety of communication signals from inside the elevator car 110 (and some proximate the elevator car 110) to be received outside the elevator shaft 115, a number of applications become available. In some embodiments, the IIoT devices 105 should be understood to include their respective wireless antenna modules, however for sake of illustration these are omitted. The IIoT devices 105 may include a camera 705 which may transmit video of the elevator car 110 interior. Signals from the camera 110 may be used to identify occupants or provide two-way video calling. In some embodiments, the number of occupants may be tracked by video recognition. In addition, the number of occupants entering and exiting an elevator car may be tracked. In other embodiments, facial recognition may be provided using the camera 705. In conjunction with or separately from the camera 705, IIoT devices 105 may include a microphone 710 and/or a speaker 715 which may be used for two-way communication between occupants and any external entity. This may include cellular calls to public safety or persons known to the occupant. Some embodiments may include a GPS sensor 720 which may accurately track the position of the elevator car including elevation. For other locations of restricted movement (for example, ships, trains, and other mobile entities), external parties may be able to accurately locate the occupant readily in case of emergency or other need. Some embodiments may include a weight sensor 725 which may be used to provide data on the current weight of the elevator car which may signals when the car is in danger of exceeding a weight limit. Some embodiments may include a proximity sensor 730 which may be outside the interior of the elevator car. The proximity sensor 730 may provide data which may be used to monitor alignment of the elevator car in the elevator shaft. Some embodiments may include a vibration sensor 740 which may monitor the vibration of the elevator car when moving or stopped. Some embodiments may include an odor sensor 745 which may detect urine and other gases which may be hazardous to the occupant and maintenance personnel in the elevator car and shaft. Some embodiments may include a temperature and/or humidity sensor 750 which may provide data on temperature and humidity in the elevator car. The sensor 750 may also detect when an excess of water is present in the elevator shaft. Some embodiments may include a smoke/particulate sensor 760 which may be configured to detect smoke or other particulates in the elevator car or shaft. Some embodiments may include an elevator car traveler sensor 765 which may detect bearing and alignment issues in the elevator car traveler and/or elevator car cables.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

Terms such as “top,” “bottom,” “front,” “rear,” “above,” “below” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference. Similarly, an item disposed above another item may be located above or below the other item along a vertical, horizontal or diagonal direction; and an item disposed below another item may be located below or above the other item along a vertical, horizontal or diagonal direction.

What is claimed is:

1. A passive extender communication system for wireless elevator communication or in other places of restricted movement, comprising:
a first antenna assembly mounted to an interior of an elevator car, wherein the first antenna assembly is configured to receive and transmit wireless radio frequency (RF) signals from the interior of the elevator car to an exterior of the elevator car;
a radiant antenna cable positioned in an elevator shaft, wherein the radiant antenna cable is RF linked to the first antenna assembly; and
a telecommunication signal source connected to the radiant antenna cable, wherein:
the telecommunication signal source is positioned externally from the elevator car, and
the telecommunication signal source is configured to transmit RF signals to the first antenna assembly and to receive RF signals from the first antenna assembly, through the radiant antenna cable.

2. The system of claim 1, further comprising:
a multiplexer/mixer connected between the telecommunication signal source and the antenna radiant cable.

3. The system of claim 2, wherein:
the telecommunication signal source comprises a plurality of different type signal sources managed by the multiplexer to communicate with the first antenna assembly.

4. The system of claim 1, wherein the first antenna assembly comprises an inside antenna module mounted to the interior of the elevator car and connected to an outside antenna element protruding through a wall of the elevator car into the elevator shaft.

5. The system of claim 1, further comprising a second antenna connected to the telecommunication signal source, wherein the second antenna is configured to communicate with entities external to a building housing the elevator car.

6. The system of claim 1, wherein the antenna cable is a leaky-wave antenna.

7. The system of claim 1, wherein the telecommunication signal source comprises a cellular repeater device or any other RF device operating up to 11 GHz.

8. The system of claim 1, further comprising Internet of Things and Industrial Internet of Things configured sensors configured to transmit environmental data related to the elevator car.

9. The system of claim 1, further comprising a camera in the elevator car, wherein the camera is connected wirelessly to the first antenna assembly and a signal from the camera to the first antenna is configured for facial recognition of any occupant in the elevator car.

10. The system of claim 1, wherein the telecommunication signal source comprises a repeater device configured to transmit and receive signals in a public safety frequency band.

11. The system of claim 1, wherein the telecommunication signal source comprises a global positioning sensor (GPS) configured to provide a location of the elevator car in the elevator shaft.

12. The system of claim 1, further comprising a land-line based connection connected to the antenna cable, wherein the land-line based connection is further connected to a rooftop antenna.

13. The system of claim 1, further comprising a two-way video and audio system wirelessly connected to the first antenna assembly.

14. The system of claim 1, further comprising a weight sensor wirelessly connected to the first antenna assembly.

15. The system of claim 1, further comprising a vibration sensor wirelessly connected to the first antenna assembly.

16. The system of claim 1, further comprising a proximity sensor wirelessly connected to the first antenna assembly, wherein the proximity sensor detects a proximity of the elevator car to the elevator shaft.

17. The system of claim 1, further comprising a temperature/humidity sensor wirelessly connected to the first antenna assembly.

18. The system of claim 1, further comprising an odor sensor wirelessly connected to the first antenna assembly, wherein the odor sensor is configured to detect gasses in the elevator car or in the elevator shaft.

19. The system of claim 1, further comprising a particulate sensor wirelessly connected to the first antenna assembly, wherein the particulate sensor is configured to detect smoke or other particulates in the elevator car or in the elevator shaft.

20. A communication system for wireless communication in locations of restricted movement, comprising:
a wireless antenna mounted to an interior of the location of restricted movement, wherein the wireless antenna is configured to receive and transmit wireless radio frequency (RF) signals;
a radiant antenna cable positioned in or proximate to the location of restricted movement, wherein the radiant antenna cable is RF connected to the wireless antenna; and
a telecommunication signal source connected to the radiant antenna cable, wherein:
the telecommunication signal source is positioned externally from the location of restricted movement, and
the telecommunication signal source is configured to transmit RF signals to the wireless antenna and to receive RF signals from the wireless antenna through the radiant antenna cable.
